(19) United States
(12) Patent Application Publication
(10) Pub. No.: US 2013/0204901 A1
(43) Pub. Date: Aug. 8, 2013

(54) APPARATUS, SYSTEM, AND METHOD FOR DATA ANALYSIS

(71) Applicant: Akshay Pottathil, San Diego, CA (US)

(72) Inventor: Akshay Pottathil, San Diego, CA (US)

(73) Assignee: SAN DIEGO STATE UNIVERSITY (SDSU) FOUNDATION, San Diego, CA (US)

(21) Appl. No.: 13/821,207

(22) PCT Filed: Sep. 9, 2011
(86) PCT No.: PCT/US11/50934

§ 371 Date: Apr. 18, 2013

Related U.S. Application Data
(60) Provisional application No. 61/381,962, filed on Sep. 11, 2010.

(51) Int. Cl. G06F 17/30

(52) U.S. Cl. CPC G06F 17/30587
USPC 707/793

(57) ABSTRACT

In alternative embodiments, the invention provides computer-implemented methods comprising: (a) representing a plurality of Data Node Archive (DNA) data elements, or a plurality of non-deoxyribonucleic acid (non-DNA) data elements, in a model having a format or organization in accordance with (or equivalent to, or analogous to) a biological deoxyribonucleic acid (DNA) model format or equivalent thereof; or, (b) a computer-implemented method comprising a subset of, substantially all, or all of the steps as set forth in the flow chart of FIG. 7.

### RELATED APPLICATIONS

This application is a national phase application claiming benefit of priority under 35 U.S.C. §371 to Patent Convention Treaty (PCT) International Application Ser. No: PCT/US2011/050934, filed Sep. 09, 2011, which claims benefit of priority to U.S. Provisional Patent Application No. 61/381,962, filed Sep. 11, 2010. The aforementioned applications are expressly incorporated herein by reference in their entirety and for all purposes.

### BACKGROUND

Today's researchers, unlike their counterparts of the past, have near real-time access to vast amounts of different types of data. The technologies grouped under the rubric “data mining” enable researchers to plow through data to generate a vast number of hypotheses in a prioritized fashion.

Offset against that advantage are the following caveats: Few data mining techniques are associated with tests of statistical significance: a suggested hypothesis does not usually come with a “p-value.” An observed relationship between an indirect indicator and an event does not, in the absence of additional knowledge, imply cause or effect. Further, because of the problem of confounding variables, the factors that may be predictors may turn out not to be so. That problem has been known since the devising of the Pearson correlation coefficient in the early 20th century. Two variables that were apparently highly correlated were found to be associated only because of a third unconsidered variable. Thus, indirect indicators may not always reflect cause-and-effect relationships.

Previous investigators have attempted to define event evolution as a function of media reporting. Cieri and colleagues (1802) proposed that an event be defined as “a specific thing that happens at a specific time and place along with all necessary pre-conditions and unavoidable consequences.” Makkonen (2003) observed that a seminal event can lead to various related events and outcomes, and the initial cause of these events may become less obvious over time.

### SUMMARY

In alternative embodiments, the invention provides computer-implemented methods comprising: (a) representing a plurality of Data Node Archive (DNA) data elements, or a plurality of non-deoxyribonucleic acid (non-DNA) data elements, in a model having a format or organization in accordance with (or equivalent to, or analogous to) a biological deoxyribonucleic acid (DNA) model format or equivalent thereof; or, (b) a computer-implemented method comprising a subset of, substantially all, or all of the steps as set forth in the flow chart of FIG. 7.

In alternative embodiments of the computer-implemented method, the representing comprises positioning the data elements within the model to generate nodes and arms of a strand of the model, the nodes representing stem-categories and the arms attached to the nodes and representing data element variables.

In alternative embodiments of the computer-implemented method, the representing comprises: representing the data elements in the model to create a plurality of strands, each strand representing at least one event; and aligning strands to determine a level of similarity between at least two strands. The aligning can generate a double helix, or equivalent, in the model.

In alternative embodiments, the computer-implemented method further comprises generating an image, or equivalent, based on the model.

In alternative embodiments, the computer-implemented method further comprises realigning the nodes; and processing location, time and variables to represent geospatial characteristics in the model.

In alternative embodiments of the computer-implemented method, the realigning and processing the location, time, and variables curves the double helix (or equivalent) in the model.

In alternative embodiments, the computer-implemented method further comprises receiving the data elements; and storing the data elements.

In alternative embodiments, the invention provides computer-implemented methods for processing data comprising:
receiving data comprising a plurality of Data Node Archive (DNA) data elements, or a plurality of non-deoxyribonucleic acid (non-DNA) data elements, related to at least one event; storing the data elements in memory;
positioning the data elements within a model in accordance with a deoxyribonucleic acid (DNA) model to generate strands having nodes and arms in the model, the nodes representing stem-categories and the arms attached to the nodes and representing variables, each strand representing one or more events; and
aligning two strands to generate a double helix in the model to indicate a level of matching between the two strands.

In alternative embodiments, the computer-implemented method further comprises: realigning the two strands; receiving additional data elements and modifying the strands based on the additional data elements; identifying the similarities between the two strands; and marking the two strands in accordance with the similarities; and/or, generating an image of the double helix (or equivalent).

In alternative embodiments, the invention provides computer program products for processing data, the computer program product comprising:
computer-executable logic contained on a computer-readable medium and configured for causing the following computer-executed step to occur:
representing a plurality of Data Node Archive (DNA) data elements, or a plurality of non-deoxyribonucleic acid (non-DNA) data elements, in a model having a format in accordance with a biological deoxyribonucleic acid (DNA) model format.

In alternative embodiments of the computer program products, the representing comprises:
positioning the data elements within the model to generate nodes and arms of a strand of the model, the nodes representing stem-categories and the arms attached to the nodes and representing data element variables, and/or
representing the data elements in the model to create a plurality of strands, each strand representing at least one event; and aligning strands to determine a level of similarity between at least two strands.

In alternative embodiments of the computer program products, the aligning generates a double helix (or equivalent) in the model.

In alternative embodiments of the computer program products, the computer-executable logic is further configured to cause the following step to occur: generating an image (or equivalent) based on the model.

In alternative embodiments of the computer program products, the computer-executable logic is further configured to cause the following steps to occur:
realigning the nodes; and
processing location, time and variables to represent geospatial characteristics in the model.

In alternative embodiments of the computer program products, the realigning and processing the location, time, and variables curves the double helix (or equivalent) in the model.

In alternative embodiments of the computer program products, the computer-executable logic is further configured to cause the following steps to occur:
receiving the data elements; and
storing the data elements.

In alternative embodiments of the computer program products, the computer-executable logic contained on a computer-readable medium and configured for causing the following computer-executed steps to occur:
receiving data comprising a plurality of Data Node Archive (DNA) data elements, or a plurality of non-deoxyribonucleic acid (non-DNA) data elements, related to at least one event;
storing the data elements in memory;
positioning the data elements within a model in accordance with a deoxyribonucleic acid (DNA) model to generate strands having nodes and arms in the model, the nodes representing stem-categories and the arms attached to the nodes and representing variables, each strand representing one or more events; and
aligning two strands to generate a double helix (or equivalent) in the model to indicate a level of matching between the two strands.

In alternative embodiments of the computer program products, the computer-executable logic is further configured to cause the following steps to occur: realigning the two strands.

In alternative embodiments of the computer program products, the computer-executable logic is further configured to cause the following steps to occur: receiving additional data elements and modifying the strands based on the additional data elements.

In alternative embodiments of the computer program products, the computer-executable logic is further configured to cause the following steps to occur: identifying the similarities between the two strands; and marking the two strands in accordance with the similarities.

In alternative embodiments of the computer program products, the computer-executable logic is further configured to cause the following steps to occur: generating an image of the double helix (or equivalent).

In alternative embodiments, the invention provides Graphical User Interface (GUI) computer program products comprising: a representation of a plurality of Data Node Archive (DNA) data elements, or a plurality of non-deoxyribonucleic acid (non-DNA) data elements, in a model having a format in accordance with a biological deoxyribonucleic acid (DNA) model format.

In alternative embodiments of the GUI computer program product, the representation comprises: nodes representing stem-categories; and, arms attached to the nodes and representing data element variables, the data elements positioned to form strands having the nodes and arms.

In alternative embodiments the GUI computer program product further comprises: representations of a plurality of strands, each strand representing at least one event; GUI indicating a level of similarity between at least two strands when the two strands are aligned.

In alternative embodiments the GUI computer program product further comprises: an image of a double helix (or equivalent) representing an alignment of the two strands.

In alternative embodiments of the GUI computer program product, the representations indicate a realigning of the nodes; and/or a geospatial characteristic or characteristics based on location, time and variables of the events.

In alternative embodiments of the GUI computer program product, the representations indicate the realigning of the nodes; and the geospatial characteristics by curving the image of the double helix (or equivalent).

In alternative embodiments, the invention provides computer systems comprising a processor and a data storage device wherein said data storage device has stored thereon: (a) a computer program product for implementing a computer-implemented method of the invention; (b) a computer program product for processing data of the invention; (c) a Graphical User Interface (GUI) computer program product of any of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides a non-transitory memory medium comprising program instructions for running, processing and/or implementing: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides a computer-readable storage medium comprising a set of or a plurality of computer-readable instructions that, when executed by a processor of a computing device, cause the computing device to run, process and/or implement: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides computer program products comprising: a computer-readable storage medium; and a set of or a plurality of program instructions residing in said storage medium which, when executed by a computer, run, process and/or implement: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides computer program storage devices, embodied on a tangible computer readable medium, comprising: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides computers or equivalent electronic systems, comprising: a memory; and a processor operatively coupled to the memory, the processor adapted to execute program code stored in the memory to: run, process and/or implement: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides a system or systems, comprising: a memory configured to: store values associated with a plurality of data points and/or a plurality of data elements, and a processor adapted to execute program code stored in the memory to: run, process and/or implement: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides computer-implemented systems for providing an application access to an external data source or an external server process via a connection server, and providing the ability to store values associated with the plurality of data points and/or the plurality of data elements, and an application for running, processing and/or implementing: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides computer-implemented methods for displaying feed data comprising a plurality of data points and/or a plurality of data elements, the computer-implemented method comprising performing computer-implemented operations for: (a) receiving feed data comprising the plurality of data points and/or the plurality of data elements; displaying at least a portion of the feed data in a plurality of nodes attached to a backbone; and upon receiving new feed data displaying at least a portion of the new feed data in a new node that is arranged in at least one of a plurality of backbones, and running, processing and/or implementing: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

In alternative embodiments, the invention provides storage devices storing program instructions executable by a processor or processors to run, process and/or implement: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof. In alternative embodiments, the invention provides systems for identifying or predicting a risk or an event comprising: (a) a computer-implemented method of the invention; (b) a computer program product of the invention; (c) a Graphical User Interface (GUI) computer program product of the invention; (d) a computer system of the invention; (e) a non-transitory memory medium of the invention; (f) a computer-readable storage medium of the invention; (g) a computer program product of the invention; (h) a computer program storage device of the invention; (i) a computer or equivalent electronic system of the invention; (j) a system of the invention; (k) a computer-implemented system of the invention; (l) a computer-implemented method for displaying feed data of the invention; (m) a storage device storing program instructions executable by a processor of the invention; or, (n) a combination thereof.

The details of one or more embodiments of the invention are set forth in the accompanying drawings and the description below. Other features, objects, and advantages of the invention will be apparent from the description and drawings, and from the claims.

All publications, patents, patent applications, GenBank sequences and ATCC deposits, cited herein are hereby expressly incorporated by reference for all purposes.

### BRIEF DESCRIPTION OF THE DRAWINGS

The following drawings are illustrative of aspects of the invention and are not meant to limit the scope of the invention as encompassed by the claims.

FIGS. 1 to 4 schematically illustrate an exemplary method of the invention for comparing and generating data in a DNA format.

FIG. 1 illustrates an exemplary method of the invention for comparing and pairing events.

FIG. 2A schematically illustrates a “stage 1” of an exemplary protocol of the invention; FIG. 2B schematically illustrates a “stage 2” of an exemplary protocol of the invention.

FIG. 3A schematically illustrates a “stage 3” of an exemplary protocol of the invention; FIG. 3B schematically illustrates a “stage 4” of an exemplary protocol of the invention.

FIG. 4A schematically illustrates a “stage 5” of an exemplary protocol of the invention; FIG. 4B schematically illustrates a “stage 6” of an exemplary protocol of the invention; FIG. 4C schematically illustrates a “stage 7” of an exemplary protocol of the invention.

FIG. 5 schematically illustrates an exemplary “DNA STRAND” within IAN for processing by BRAIN for a Binary Data Matching, which can be visualized in 3D, as described in detail below.

FIG. 6 schematically illustrates an exemplary “dimensions chart”: the grey strand represents the Species and the two orange is the intersection point (shared feature from another species); tiling on (zooming in to) any of these points can change the course of the search into another relationship, as described in detail below.

FIG. 7 is a flow chart schematically illustrates and describes an exemplary computer-implemented embodiment of the invention, as described in detail below.

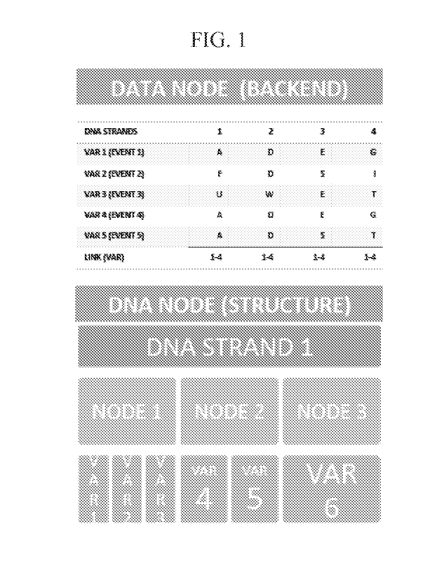

Like reference symbols in the various drawings indicate like elements.

### DETAILED DESCRIPTION

In alternative embodiments the invention provides methods, systems and apparatus for data analysis using e.g., at least one event node comprising a plurality of data elements. The methods, systems and apparatus of the disclosure are capable of identifying similar geospatial events. Given that a prediction of related events is important for identifying risks.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying” or the like, refer to the actions and processes of a computer system, or similar electronic computing device that manipulates and transforms data represented as physical (e.g., electronic) quantities within the computer system's registers and memories into other data similarly represented as physical quantities within the computer system memories or registers or other such information storage, transmission, or display devices.

The invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the method steps. The structure for a variety of these systems will appear from the description below. In addition, the present invention is not described with reference to any particular programming language. It will be appreciated that a variety of programming languages may be used to implement the teachings of embodiments of the invention as described herein.

In alternative embodiments, a machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage media, optical storage media, flash memory devices, etc.), a machine-readable transmission medium (electrical, optical, acoustical or other form of propagated signals (e.g., carrier waves, infrared signals, digital signals, etc.)), etc.

In the following description, numerous details are set forth. It will be apparent, however, to one skilled in the art, that the present invention may be practiced without these specific details.

By analogy the methods, systems and devices of the disclosure convert information available from any number of various databases to a data structure similar to biological DNA, the genetic code of life. DNA is made up of a sugar backbone having various nucleotide bases (A, G, T, and C) that are in a sequence along the backbone to encode key structures of life (e.g., proteins). DNA normally exists in the human body as a double-stranded helix, wherein bases of A match with T and bases of G match with C. When a single strand of DNA matches a second strand of DNA the strands are said to be complementary (i.e., the bases align along the backbones).

In alternative embodiments, “complementarity” can be defined as a percent identity, e.g., in alternative embodiments, two strands are 80%, 81%, 82%, 83%, 84%, 85%, 86%, 87%, 88%, 89%, 90%, 91%, 92%, 93%, 94%, 95%, 96%, 97%, 98%, 99%, or more, or completely (100%) identical, or 80%, 81%, 82%, 83%, 84%, 85%, 86%, 87%, 88%, 89%, 90%, 91%, 92%, 93%, 94%, 95%, 96%, 97%, 98%, 99%, or more, or completely complementary. The more complementary two strands, the more likely the resulting code is to encode a particular protein, or in the case of the present invention, an event. In alternative embodiments, the invention provides methods, system and device tools that aid data fusion, pattern recognition, and geo-spatial visualization leveraging tools from biologically inspired computing, computational neurosciences, persuasive science, and behavior modeling.

In alternative embodiments, a server collects data from either a data mining process or user input. This information is transformed into a Data Node Analysis sequence. The information is updated in real-time for changes that may occur within the data sets.

In alternative embodiments, the Data Node Analysis creates a detailed structure for data and offers the ability to visualize them. Data Node Archive (DNA) is a method of information indexing of all known data. This structure is designed very similarly to human DNA structure to identify the makeup of data with variables similar to that of human DNA, however in the DNA data structure of the disclosure the data form the “bases” or rungs.

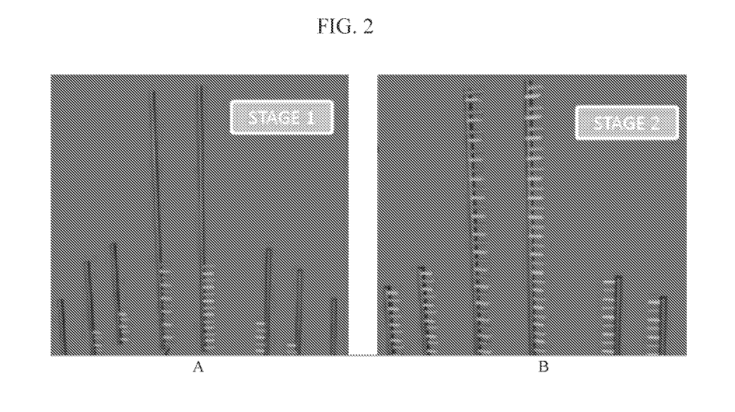

In alternative embodiments, Data Node Archive is a coded blueprint with instructions to construct predictive analysis, information mining, and geo-spatial visualization. Referring to FIG. 2, the system consists of repeating structural units known as nodes attached to a backbone. The arms that extend out from the bone are categorized data elements. The code is read and translated within e.g., the program BRAIN (Binary Risk Analysis Intelligence Network), or equivalent, which in one embodiment is the reader that translates binary instructions (on/off or true/false).

In alternative embodiments the database stores information and provides the variables for generating the Data Node Analysis Strands to conduct pattern recognition or detailed analysis. The connections are based on similarity in entire content or a single variable. In a few of the nodes, most of the variables may match. The structure is based on nodes (stem-category) and arms (variables) that are attached to the nodes—thus, these objects can vary greatly in size, shape, and volume.

In alternative embodiments, Data Node Analysis of the invention comprises seven steps to generate and process the stages starting with the inception of data and finishing with a complete application-generated double-helix image (each helix represents a separate incident).

In alternative embodiments, the data is collected and input into the database or generated from a new event, which is activated and produces initial results (see, e.g., FIG. 2A). Data gets added in real-time as it becomes available. Data may be obtained from any number of existing databases, news reports, business information, personal information, financial information, medical information, vehicle information and the like. Generally the data can take any form currently available and identified for various purposes.

In alternative embodiments, the data being collected has stabilized or the activated event is forced to process the acquired data. The strands with most complete nodes and variables are selected and aligned based on similarity, e.g., as illustrated in FIG. 2B.

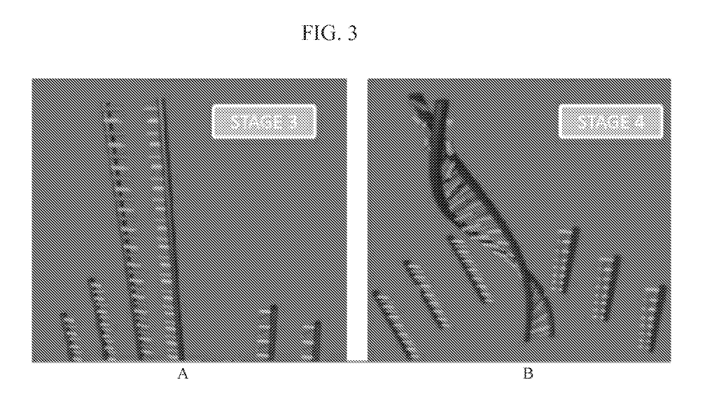

In alternative embodiments, the data is prepared for analysis and nodes are verified for accuracy and errors. Similar structures are checked and geospatial information is gathered and distributed. Archive data structures or library are referenced, e.g., as illustrated in FIG. 3A.

In alternative embodiments, the system corrects and realigns the nodes, if needed, and produces geo-spatial processing of data with location, time, and variables. This process curves the processed data sets and sections creating a visually similar structure to the biological DNA strand (FIG. 3B). Non-matching (non-complementary) strands are removed and used for realignment with other strands.

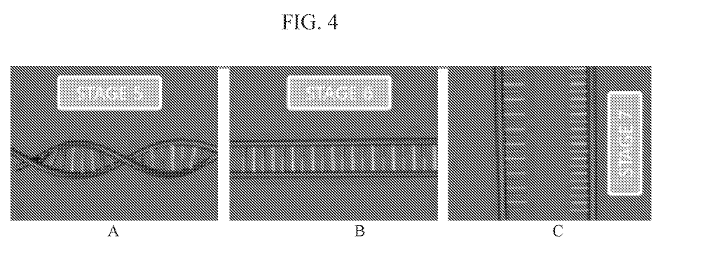

In alternative embodiments, upon identification of a pattern then the system begins to process all the information associated with the strands and gathers information from alternate sources (if available) and restructures the strands for stability, e.g., as illustrated in FIG. 4A.

In alternative embodiments, the strands when complete are reproduced for BRAIN (Binary Risk Analysis Intelligence Network) to process and IAN (Information Analysis

Network) to store. The replicated information begins to be received in stage 1 and continually adds additional information until stage 5. The two strands generally will have shifted in shape and similarity. The percentage of similarity in general and core variables are marked for reference and added to the strands with the identity of each partner marked into the other for future reference, e.g., as illustrated in FIG. 4B.

In alternative embodiments, Stage 7 splits the data structures back and stores them into the database (replacing the original—shorter data). The process repeats itself and provides IAN with content and BRAIN with preliminary data and probability, e.g., as illustrated in FIG. 4C.

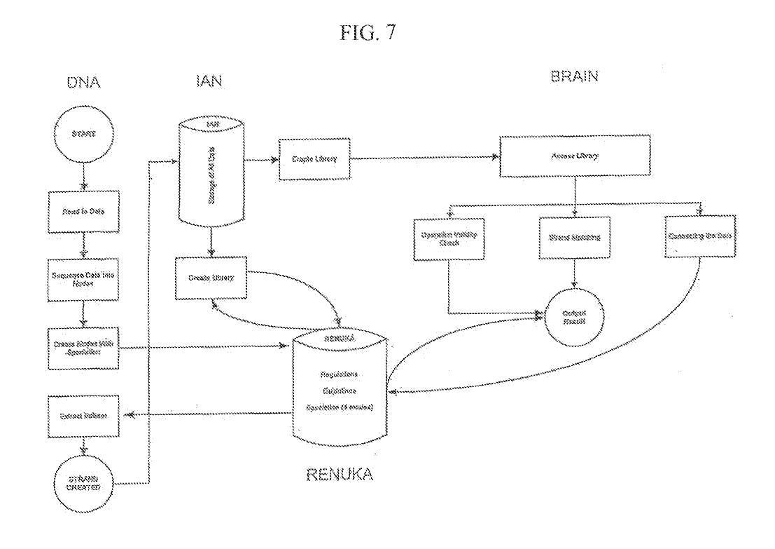

FIG. 7 is a flow chart schematically illustrates and describes an exemplary computer-implemented embodiment of the invention, including in one alternative embodiment: steps: “start”, to “read in data”, to “sequence data into nodes”, to “create nodes with speciation”, to “RENUKA” (regulations, guidelines, speciation), then either to “extract pattern” then to “strand created”, or to “output result”, or to “strand created”. In one embodiment, “strand created” step” goes to “IAN (storage of all data)”, which either goes to “create library”, then to “RENUKA”, which can feed back to “create library”, or to a “create library” to “access library” to “strand matching” to “output result” path (which alternatively can be either: a “create library” to “access library” to “operation validity check” to “output result” path; or, a “create library” to “access library” to “connecting the dots” to “RENUKA” path).

### Data Node Archive (DNA) and BRAIN

In alternative embodiments, the computer-implemented methods of the invention comprised use of Data Node Archive (DNA), which comprises a method of visual information indexing of any type of data. This structure is designed very similarly to that of a human DNA structure for identifying the makeup of data with variables transforming into nodes. In alternative embodiments Data Node Archive becomes a coded blueprint with instructions to construct predictive analysis, information mining, and geo-spatial visualization. The patterns generated from DNA are referred to as strands. The system consists of repeating structural units known as nodes attached to a backbone (Species). The arms that extend out from the bone are categorized data elements. The code is read and translated within BRAIN, which is the reader that translates binary instructions (on/off or true/false). Binary Risk Analysis Intelligence Network (BRAIN) filters DNA; it is an application that is able to check the DNA strands for similarity and variation. The BRAIN accesses a library stored in the Information Analysis Network (IAN)—a network of libraries that store various DNA strands.

The BRAIN program has three modes—operation validity check, strand matching, and connecting the dot:
OPERATION VALIDITY CHECK
IF THE [INPUT STRAND]=[GD12312,2B,1] THEN THE DATA READS AS “The team has entered the building, the building is vacant, and bad intelligence was provided.”
ELSE
IF THE [INPUT STRAND]=[GD12312,3A,1] THEN THE DATA READS AS The team has entered the building, the building is partially occupied, and the intelligence provided is accurate.
ELSE
IF THE [INPUT STRAND]=[GD12312, X] OR [OTHER] THEN THE DATA
READS AS “The data received is not functional” or “Error”. STRAND MATCHING

BRAIN searches the speciation for the arms that can accept the possible strand. For example a strand coming back with a format GD123XX, X, A32 will be searched across the GD stream to the entire possible message that could be translated from the message. Then refines it based on the probability based on guidelines set forth in regulatory library known as (RENUKA).

The server collects data from either a data mining process or user input. The information is updated in real-time as changes occur within the data sets. The Data Node Archive creates a detailed structure for data and offers the ability to visualize them in a geo-spatial context. The database stores information and sorts the variables to generate the strands for pattern recognition and data analysis. The matches are based on similarity in complete pattern or amongst arms of the strands. In a few of the nodes, most of the variables may match, however a slight difference can even make a difference.

An example would be the births of two identical twins that share exact genes produce a match of only 98% based on 100 variables in the Node Archive Strand because the time of birth and the name given at birth is different. As they grow older their similarity level becomes less and the variables go up. At the age of one (1) the child could have a 95% similarity with 10,000 variables logged—however that doesn't change the fact they are identical twins and at the first glance even their own parents cannot tell them apart.

Another use of this technology is to communicate battleground information for the troops. The patterns are transmitted as DATA NODES and a line with two vertical lines are transmitted as 1,1A,2B. The first number one (1) represents the line and one A (1A) refers to the first vertical line, and one B (1B) refers to the second vertical line. The transmission of 1,2B could translate into “Abort” and 1,1A could mean “Engage”. The strand 1 can be an instruction for an operative in a particular operation (known as “Species” in the DNA). The structure is based on nodes (stem-category) and arms (variables) that are attached to the backbone (Species); hence, these objects may vary greatly in size, shape, and volume.

In alternative embodiments, the strands when complete are reproduced for BRAIN (Binary Risk Analysis Intelligence Network) to process and IAN (Information Analysis Network) to store:

### EXAMPLE OF DNA STRAND FROM IAN

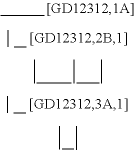

The pattern being analyzed is highlighted below:

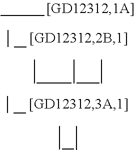

The information processed internally is that the team has entered the building, the building is vacant, and bad intelligence was provided. If the code were to omit the one (1) at the end then the “bad intelligence was provided” would not be included.

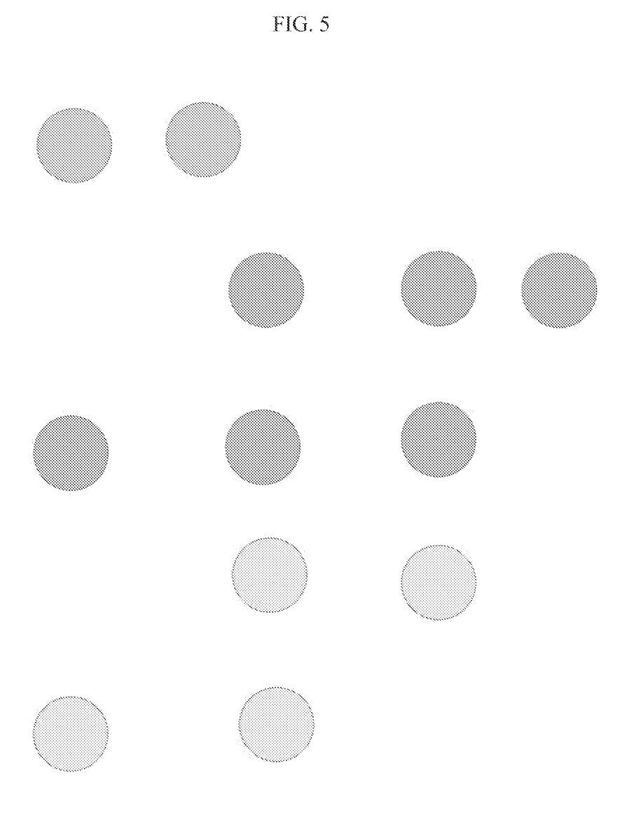

An example of DNA STRAND [GD12312] within IAN: for processing by BRAIN for a Binary Data Matching is illustrated in FIG. 5, which can be visualized in 3D.

BRAIN Matching:

The tag [GD12312,2B,1], will cross reference all [GDXXXXX,2B,1] to see all operations within the network that had a team enter a building, the building is vacant, and bad intelligence was provided. The ability to pick and choose patterns of failure and errors can help connect the intelligence “dots” to strengthen national security and defense.

Implementation:

DNA can be implemented for wide range of information exchange ranging from counter terrorism to unencrypted data transfer of classified information. The OSINT (Open Source Intelligence) can generate patterns that can be matched with Closed Source Intelligence systems for information dominance

The possible implications make DNA a valuable tool for government, non-governmental agencies, private organizations, and interest groups alike. An example of private organization use is an energy company offering tools for consumers to be more active of their power efficiency without sacrificing user privacy and security with implementation of things such as “smart meter”.

Speciation (RENUKA):

The categories of data within libraries are generated through speciation (splitting of lineages). The regulations for speciation are stored within RENUKA (Regulatory Environment Norms Under Known Adaptation). RENUKA is an evolving library of species and regulations (both local and global) and the values of nodes. Like nature there are four geographic modes of speciation—they are allopathic (a population splits into two geographically isolated populations), peripatric (a subform of allopatric speciation where a new species are formed in isolated), parapatric (there is only partial separation of the zones of two diverging populations afforded by geography), and sympatric (species diverge while inhabiting the same place).

Example of IGD123121 DNA Strand stored inside IAN:

[GD12312]=The team has entered the building. [GD 12312,1A]=The team has entered the building, the building is occupied. [GD12312,2B]=The team has entered the building, the building is vacant. [GD12312,2B,1]=The team has entered the building, the building is vacant, and bad intelligence was provided.

[GD12312,3A] =The team has entered the building, the building is partially occupied. [GD12312,3A,1] =The team has entered the building, the building is partially occupied, and the intelligence provided is accurate.

*Such communication limits the information leak and protects privacy of the operators or individuals that the data is being communicated about.

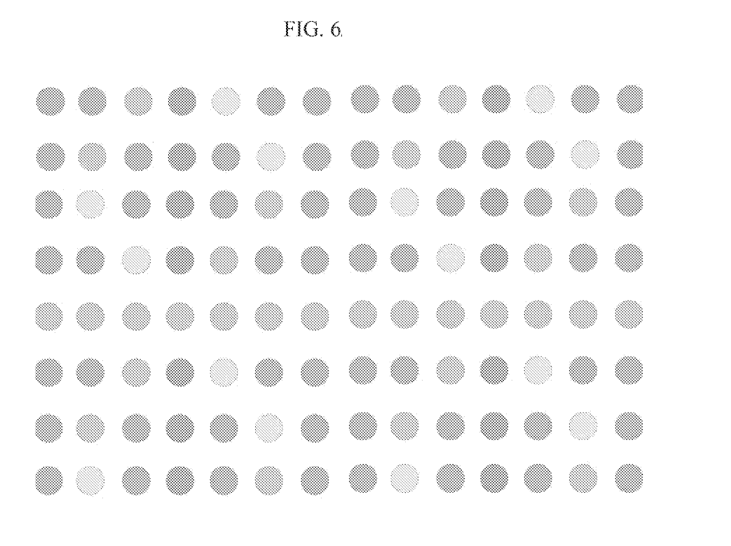

Dimensions The dimensions are created for tiled searching of strands. The DNA strands are aligned using a relationship tool. Each has a 360-degree tilt. Each degree or sub degrees take the relationship into a new direction. An example of a dimensions chart is in FIG. 6. The grey strand represents the Species and the two orange is the intersection point (shared feature from another species). Tiling on (zooming in to) any of these points can change the course of the search into another relationship. This helps to “connect the dots”.

Structured Altering

In alternative embodiments, structured altering of processes and computer implemented methods of the invention can produce robust encryption techniques as altering of the data output via a mutually agreed upon sequence, shift, or algorithm for processing would completely change the apparent “species” of the information. Structured alteration of the workflow at almost every point and then re-alteration on the client side or with variables such as user name/password so that only certain people see the correct workflow or level of exactness according to their pre-agreed role such as security clearance or role in project.

Because the answers are provided out as species, which in nature are identified by things like form (e.g., cat with colors, size, hair, eye color—host of features), the information can also be transformed into actual species that could be discerned by someone who is a “cat person” who is visually interrogating a picture or image and obtaining the critical information components that can be used as encryption components.

Using real species and relationships such as could be best understood by a biologist, botanist, or paleontologist, it would be possible to both encrypt and decrypt data by marrying real species and relationships to Data Node Archive relationships.

Much like DNA can be compared and relative closeness and relationships determined, the shapes and relationships (categories) of data can be defined to produce a multi-dimensional (3D plus time plus other attributes like color, transparency, sound, brightness) display of relationships to data. As an example, data patterns equated to sound can be compared with other data patterns to show similarity or differences (same tune, similar tune, enhanced tune like jazz). All of these are simply variations on the DNA pattern and can be altered in a structured way to produce a potent encryption and cybersecurity set of tools. Similarly, data can be hidden in the data (as using the spaces in a message as an additional message besides what the letters and words say). So, adding data to data such as adding a bug on the back of a cow would provide a separate pathway to move information, much as the DNA of the bug provides different information than the cow, but both are DNA and are together. Nested data, such as DNA in the bacteria of a cow's stomach, could be contained with DNA (Data Node Archive) “wrappers” covering smaller nodes inside the larger node. This is functionally using DNA as building blocks to build large DNA components.

Computer Systems and Data Storage Devices

The methods of the invention, in whole or in part, necessarily require implementation using a machine, computer system or equivalent, within which a set of instructions for causing the computer or machine to perform any one or more of the protocols or methodologies of the invention may be executed. In alternative embodiments, the machine may be connected (e.g., networked) to other machines, e.g., in a Local Area Network (LAN), an intranet, an extranet, or the Internet, or any equivalents thereof. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. The term “machine” shall also be taken to include any collection of machines, computers or products of manufacture that individually or jointly execute a set (or multiple sets) of instructions to perform any one or more of the methodologies of the invention.

In alternative embodiments, an exemplary computer system of the invention comprises a processing device (processor), a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device, which communicate with each other via a bus.

In alternative embodiments, a processor represents one or more general-purpose processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor may also be one or more special-purpose processing devices such as an application specific integrated circuit (ASIC), a field programmable gate array (FPGA), a digital signal processor (DSP), network processor, or the like. In alternative embodiments the processor is configured to execute the instructions (e.g., processing logic) for performing the operations and steps discussed herein.

In alternative embodiments the computer system further comprises a network interface device. The computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

In alternative embodiments, the data storage device (e.g., drive unit) comprises a computer-readable storage medium on which is stored one or more sets of instructions (e.g., software) embodying any one or more of the protocols, methodologies or functions of this invention. The instructions may also reside, completely or at least partially, within the main memory and/or within the processor during execution thereof by the computer system, the main memory and the processor also constituting machine-accessible storage media. The instructions may further be transmitted or received over a network via the network interface device.

In alternative embodiments the computer-readable storage medium is used to store data structure sets that define user identifying states and user preferences that define user profiles. Data structure sets and user profiles may also be stored in other sections of computer system, such as static memory.

In alternative embodiments, while the computer-readable storage medium in an exemplary embodiment is a single medium, the term “machine-accessible storage medium” can be taken to include a single medium or multiple media (e.g., a centralized or distributed database, and/or associated caches and servers) that store the one or more sets of instructions. In alternative embodiments the term “machine-accessible storage medium” can also be taken to include any medium that is capable of storing, encoding or carrying a set of instructions for execution by the machine and that cause the machine to perform any one or more of the methodologies of the present invention. In alternative embodiments the term “machine-accessible storage medium” shall accordingly be taken to include, but not be limited to, solid-state memories, and optical and magnetic media.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1-43. (canceled)

44. A computer-implemented method comprising:
(a)
(i) representing a plurality of Data Node Archive (DNA) data elements, or a plurality of non-deoxyribonucleic acid (non-DNA) data elements, in a model having a format or organization in accordance with (or equivalent to, or analogous to) a biological deoxyribonucleic acid (DNA) model format or equivalent thereof; or,
(ii) a computer-implemented method comprising a subset of, substantially all, or all of the steps as set forth in the flow chart of FIG. 7;
(b) the computer-implemented method of (a), wherein the representing comprises: positioning the data elements within the model to generate nodes and arms of a strand of the model, the nodes representing stem-categories and the arms attached to the nodes and representing data element variables;
(c) the computer-implemented method of (a) or (b), wherein the representing comprises: representing the data elements in the model to create a plurality of strands, each strand representing at least one event; and aligning strands to determine a level of similarity between at least two strands.;
(d) the computer-implemented method of (c), wherein the aligning generates a double helix in the model;
(e) the computer-implemented method of any of (a) to (d), further comprising: generating an image based on the model;
(f) the computer-implemented method of any of (b) to (e), further comprising: realigning the nodes; and processing location, time and variables to represent geospatial characteristics in the model;
(g) the computer-implemented method of any of (a) to (f), wherein the realigning and processing the location, time, and variables curves a double helix in the model; or
(h) the computer-implemented method of any of (a) to (g), further comprising: receiving the data elements; and storing the data elements.

45. A computer-implemented method of processing data comprising:
(a) (i) receiving data comprising a plurality of Data Node Archive (DNA) data elements, or a plurality of non-deoxyribonucleic acid (non-DNA) data elements, related to at least one event;
(ii) storing the data elements in memory;
(iii) positioning the data elements within a model in accordance with a deoxyribonucleic acid (DNA) model to generate strands having nodes and arms in the model, the nodes representing stem-categories and the arms attached to the nodes and representing variables, each strand representing one or more events; and
(iv) aligning two strands to generate a double helix in the model to indicate a level of matching between the two strands;
(b) the computer-implemented method of (a), further comprising: realigning the two strands;
(c) the computer-implemented method of (a) or (b), further comprising:
receiving additional data elements and modifying the strands based on the additional data elements;
(d) the computer-implemented method of any of (a) to (c), further comprising:
identifying the similarities between the two strands; and marking the two strands in accordance with the similarities; or (e) the computer-implemented method of any of (a) to (d), further comprising generating an image of the double helix.

46. A computer program product for processing data, the computer program product comprising:
(a) a computer-executable logic contained on a computer-readable medium and configured for causing the following computer-executed step to occur:
representing a plurality of Data Node Archive (DNA) data elements, or a plurality of non-deoxyribonucleic acid (non-DNA) data elements,
in a model having a format in accordance with a biological deoxyribonucleic acid (DNA) model format.
(b) the computer program product of (a), wherein the representing comprises: positioning the data elements within the model to generate nodes and arms of a strand of the model, the nodes representing stem-categories and the arms attached to the nodes and representing data element variables;
(c) the computer program product of (a) or (b), wherein the representing comprises: representing the data elements in the model to create a plurality of strands, each strand representing at least one event; and aligning strands to determine a level of similarity between at least two strands;
(d) the computer program product of any of (a) to (c), wherein the aligning generates a double helix in the model;
(e) the computer program product of any of (a) to (d), wherein the computer-executable logic is further configured to cause the following step to occur: generating an image based on the model;
(f) the computer program product of any of (a) to (e), wherein the computer-executable logic is further configured to cause the following steps to occur: realigning the nodes; and, processing location, time and variables to represent geospatial characteristics in the model;
(g) the computer program product of any of (a) to (f), wherein the realigning and processing the location, time, and variables curves the double helix in the model; or
(h) the computer program product of any of (a) to (g), wherein the computer-executable logic is further configured to cause the following steps to occur: receiving the data elements; and storing the data elements.

47. A computer program product for processing data, the computer program product comprising:
(a) a computer-executable logic contained on a computer-readable medium and configured for causing the following computer-executed steps to occur:
(i) receiving data comprising a plurality of Data Node Archive (DNA) data elements, or a plurality of non-deoxyribonucleic acid (non-DNA) data elements, related to at least one event;
(ii) storing the data elements in memory;
(iii) positioning the data elements within a model in accordance with a deoxyribonucleic acid (DNA) model to generate strands having nodes and arms in the model, the nodes representing stem-categories and the arms attached to the nodes and representing variables, each strand representing one or more events; and
(iv) aligning two strands to generate a double helix in the model to indicate a level of matching between the two strands.
(b) the computer program product of (a), wherein the computer-executable logic is further configured to cause the following steps to occur: realigning the two strands;
(c) the program product of (a) or (b), wherein the computer-executable logic is further configured to cause the following steps to occur: receiving additional data elements and modifying the strands based on the additional data elements;
(d) the computer program product of any of (a) to (c), wherein the computer-executable logic is further configured to cause the following steps to occur: identifying the similarities between the two strands; and, marking the two strands in accordance with the similarities; or (e) the computer program product of any of (a) to (d), wherein the computer-executable logic is further configured to cause the following steps to occur: generating an image of the double helix.

48. A Graphical User Interface (GUI) computer program product comprising:
(a) a representation of a plurality of Data Node Archive (DNA) data elements, or a plurality of non-deoxyribonucleic acid (non-DNA) data elements, in a model having a format in accordance with a biological deoxyribonucleic acid (DNA) model format;
(b) the GUI computer program product of (a), wherein the representation comprises: nodes representing stem-categories; and arms attached to the nodes and representing data element variables, the data elements positioned to form strands having the nodes and arms;
(c) the GUI computer program product of (a) or (b), further comprising: representations of a plurality of strands, each strand representing at least one event; the GUI indicating a level of similarity between at least two strands when the two strands are aligned;
(d) the GUI computer program product of any of (a) to (c), further comprising an image of a double helix representing an alignment of the two strands;
(e) the GUI computer program product of any of (a) to (d), wherein the representations indicate: a realigning of the nodes; and, geospatial characteristics based on location, time and variables of the events; or
(f) the GUI computer program product of any of (a) to (e), wherein the representations indicate the realigning of the nodes; and the geospatial characteristics by curving the image of the double helix.

49. A computer system comprising a processor and a data storage device wherein said data storage device has stored thereon: a computer program product for implementing a computer-implemented method of claim 44.

50. A non-transitory memory medium comprising program instructions for running, processing and/or implementing: a computer program product for implementing a computer-implemented method of claim 44.

51. A computer-readable storage medium comprising a set of or a plurality of computer-readable instructions that, when executed by a processor of a computing device, cause the computing device to run, process and/ or implement: a computer program product for implementing a computer-implemented method of claim 44.

52. A computer program product comprising: a computer-readable storage medium; and program instructions residing in said storage medium which, when executed by a computer, run, process and/ or implement: a computer program product for implementing a computer-implemented method of claim 44.

53. A computer program storage device, embodied on a tangible computer readable medium, comprising: a computer program product for implementing a computer-implemented method of claim 44.

54. A computer or equivalent electronic system, comprising: a memory; and a processor operatively coupled to the memory, the processor adapted to execute program code stored in the memory to: a computer program product for implementing a computer-implemented method of claim 44.

55. A system, comprising: a memory configured to: store values associated with a plurality of data points and/or a plurality of data elements, and a processor adapted to execute program code stored in the memory to: a computer program product for implementing a computer-implemented method of claim 44.

56. A computer-implemented system for providing an application access to an external data source or an external server process via a connection server, and providing the ability to store values associated with the plurality of data points and/or the plurality of data elements, and an application for running, processing and/or implementing: a computer program product for implementing a computer-implemented method of claim 44.

57. A computer-implemented method for displaying feed data comprising a plurality of data points and/or a plurality of data elements, the computer-implemented method comprising performing computer-implemented operations for: receiving feed data comprising the plurality of data points and/or the plurality of data elements; displaying at least a portion of the feed data in a plurality of nodes attached to a backbone; and upon receiving new feed data displaying at least a portion of the new feed data in a new node that is arranged in at least one of a plurality of backbones, and running, processing and/or implementing: a computer program product for implementing a computer-implemented method of claim 44.

58. A storage device storing program instructions executable by a processor to run, process and/or implement: a computer program product for implementing a computer-implemented method of claim 44.

59. A system for identifying or predicting a risk or an event comprising: a computer program product for implementing a computer-implemented method of claim 44.

60. A computer system comprising a processor and a data storage device wherein said data storage device has stored thereon: a Graphical User Interface (GUI) computer program product of claim 48.

61. A non-transitory memory medium comprising program instructions for running, processing and/or implementing: a Graphical User Interface (GUI) computer program product of claim 48.

62. A computer-readable storage medium comprising a set of or a plurality of computer-readable instructions that, when executed by a processor of a computing device, cause the computing device to run, process and/ or implement: a computer program product for implementing a Graphical User Interface (GUI) computer program product of claim 48.

63. A system for identifying or predicting a risk or an event comprising: a computer program product for implementing a Graphical User Interface (GUI) computer program product of claim 48.
